(19) United States
(12) Patent Application Publication
(10) Pub. No.: US 2003/0192142 A1
(43) Pub. Date: Oct. 16, 2003

(54) Hand-held device or tool for forming plastic masses, especially for producing and/or forming raised profiles

(76) Inventor: Nadine Veith, Ortenburg (DE)

Correspondence Address: Hoffman, Wasson & Gitler, P.C., Suite 522, 2361 Jefferson Davis Highway, Arlington, VA, 22202, US

(21) Appl. No.: 10/354,162

(22) Filed: Jan. 30, 2003

(30) Foreign Application Priority Data
Apr. 10, 2002 (DE) 202 05 532.9
Dec. 27, 2002 (DE) 202 20 142.2
Jan. 8, 2003 (DE) 103 00 180.8
Jan. 18, 2003 (DE) 203 00 783.2

(51) Int. Cl. B05C 17/10

(52) U.S. Cl. 15/235.4; 15/245.1; 15/235.7

(57) ABSTRACT

A hand-held tool to produce bead-like profiles or joints in a single process without the necessity of separation agents. The avoidance of use of such separating agents results in improved durability of the joint produced with the tool, in particular with regard to the sealing function. Due to the chamfer on the peripheral sides formed in the corner areas with the recess, these peripheral sides form elastic tool or scraping edges, with which the surface is adjacent to the bead-like joint are cleaned or scraped off during forming of the joint mass. After forming of the bead-like joint, reworking of the adjacent sides is therefore not necessary.

The invention relates to a hand-held device or tool as claimed in the preamble to claim 1 and thereby in particular to a tool for producing and/or forming a visible part of corner joints and/or seals, also expansion joints, gaskets, buffers, etc.

Especially in completing the interiors of buildings there is very often the need to produce sealing or expanding joints from a suitable plastic, pliable and hardenable joint material, such as rubber, silicone, acrylic, Sikaflex adhesive, Sikaflex silicone, etc. or from a filler or putty, such as plaster etc., in a corner area, i.e. between two surfaces forming a corner, such as between a vertical wall surface and an additional adjacent horizontal surface.

The object of the present invention is to present a hand-held device or tool with which raised or bead-like profiles or joints can be achieved in an especially simple manner. To achieve this object, a tool according to claim 1 is embodied.

“Raised profile” or “bead-like” profile as used in the present invention refers to a profile, especially the visible part or corner joint, with a convex shape in cross section at least on part of its visible outer surface.

The tool according to the invention makes it possible to product such bead-like profiles or joints in one process without reworking, especially without the use of separating agents, such as soapy water, vinegar, saliva, etc. The avoidance of such separating agents results in improved durability of the joint produced with the tool according to the invention and a high degree of permanence, in particular with regard to the sealing function. The increased stability of the joints produced with the tool according to the invention also prevents tearing of the joints during cleaning, e.g. with brushes, scrubbing sponges, etc.

Due to the chamfer on the peripheral sides forming the corner area with the recess, these peripheral sides form elastic tool or scraping edges, with which the surfaces adjacent to the bead-like joint are cleaned or scraped off during forming of the joint mass. After forming of the bead-like joint, reworking of the adjacent surfaces is therefore not necessary.

The tool according to the invention is suitable for processing a wide variety of plastic, formable joint masses, for example rubber, silicon, acrylic, Sikaflex adhesive, Sikaflex silicone and a wide variety of filler and putty masses, such as plaster and other masses used in interior work.

The tool according to the invention and the tool body constituting this tool are made of an elastic plastic and thereby especially of a plastic that does not bind with the commercially available joint or filler masses, so that any remaining joint and/or filler masses on the tool can be easily removed.

The invention is described below based on sample embodiments depicted in the drawings.

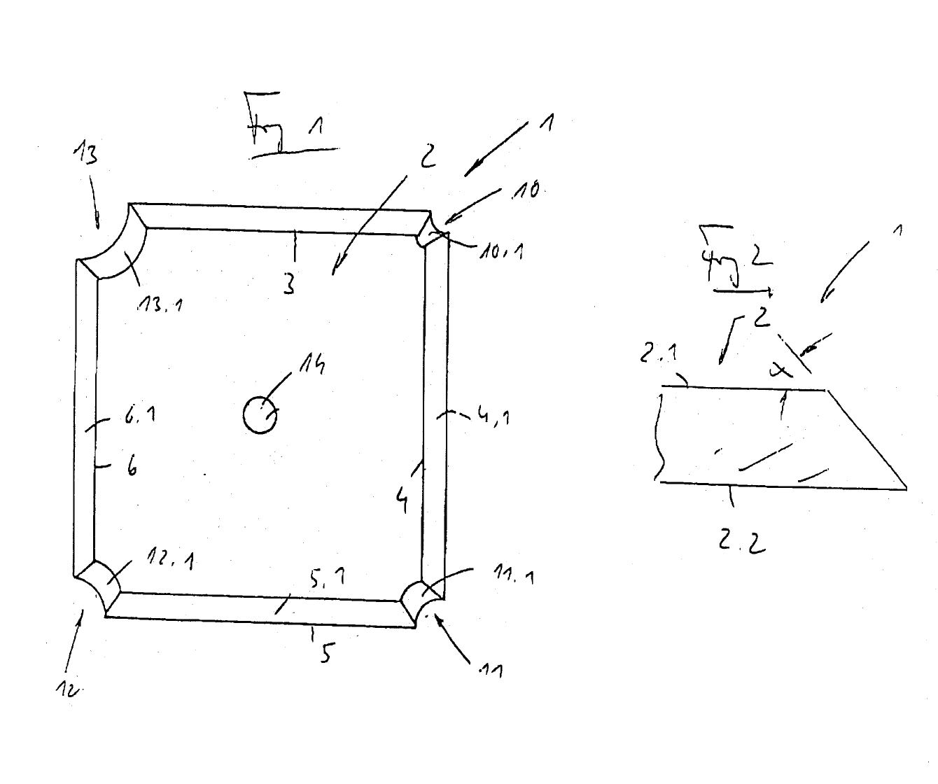

FIG. 1 shows a simplified representation in top plan view of a tool in accordance with the invention;

FIG. 2 shows a partial cross section of the tool of FIG. 1;

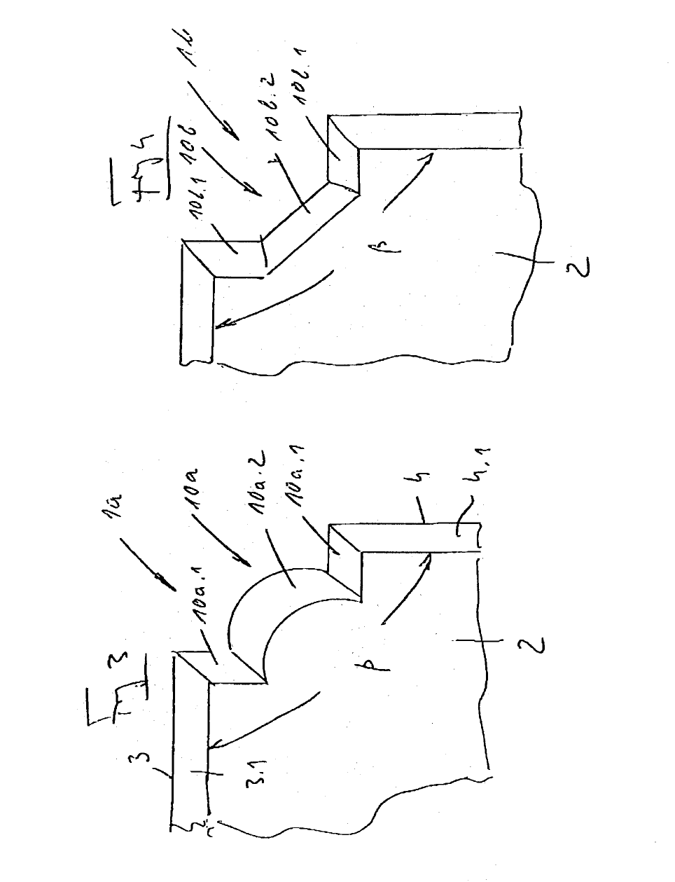

FIGS. 3-5 show partial representations of further possible embodiments of the tool according to the invention;

FIGS. 6-9 show partial representations in cross section of a joint that is formed between two surfaces that meet at right angles and that is produced by means of a joint material using the tool in FIGS. 1, 3, 4 or 5.

The tool generally designated 1 in FIG. 1 consists of a plate 2 that is made of a suitable material, e.g. of a pliable plastic and that has an essentially square shape in the top plan view of FIG. 1, with four peripheral sides 3-6, which corresponding to the square shape of the plate 2 in this embodiment are connected with each other at right angles. The plate 2 is beveled on each peripheral side, i.e. is provided with a beveled surface or chamfer 3.1, 4.1, 5.1 and 6.1, such that the respective beveled surface forms an angle a smaller than 90° with the top side 2.1 and the bottom side 2.2 of the plate 2.

In order to form the raised joint designated 7 in FIG. 6 in the corner between two surfaces 8 and 9 forming an angle of 90° in the depicted embodiment, the plate 2 is provided with a recess in the corner areas between the connecting peripheral sides 3-6 and the beveled surfaces 3.1-6.1, in the depicted embodiment with four recesses 10-13, which are essentially concave in shape, i.e. complementary to the form of the raised joint 7. Each recess 10-13 likewise has a beveled surface or chamfer 10.1-13.1: the recess 10 at the joining of the peripheral sides 3 and 4 the beveled surface 10.1; the recess 11 at the transition between the peripheral sides 4 and 5 the beveled surface 11.1; the recess 12 at the transition between the peripheral sides 5 and 6 the beveled surface 1 2.1; and the recess 13 at the transition between the peripheral sides 6 and 3 the beveled surface 13.1. All beveled surfaces 10.1-13.1 likewise form the angle a or another angle smaller than 90° with the top side 2.1.

In the depicted embodiment the recesses 10-13 are formed such that their beveled surfaces 10.1-13.1 each are partial surfaces of an imaginary circular cylinder, the axis of which forms the angle a with the plane of the top side 2.1. Furthermore, the recesses are shaped such that the circular arc-shaped edge formed by the respective recess on the top side 2.1 or the bottom side 2.2 extends along an angle area of 90° or somewhat more than 90°.

In order to form raised joints 7 with profiles of different sizes, the recesses 10-13 are of different sizes, i.e. each has a different radius, which is, for example, between 5 and 16 mm. The plate 2 is additionally provided with a hole 14 in the middle.

In order to produce the raised corner joint 7, a sufficient quantity of joint mass is applied in the corner area between the surfaces 8 and 9. Afterwards, in order to form the joint 7, the tool 1 is brought to bear for example with the beveled surfaces 3.1 and 6.1 against the surfaces 8 and 9, respectively, so that the recess 13 is located in the corner of the surfaces 8 and 9. By moving the tool 1 along the corner formed by the surfaces 8 and 9, the raised corner joint 7 is then formed by means of the recess 13.

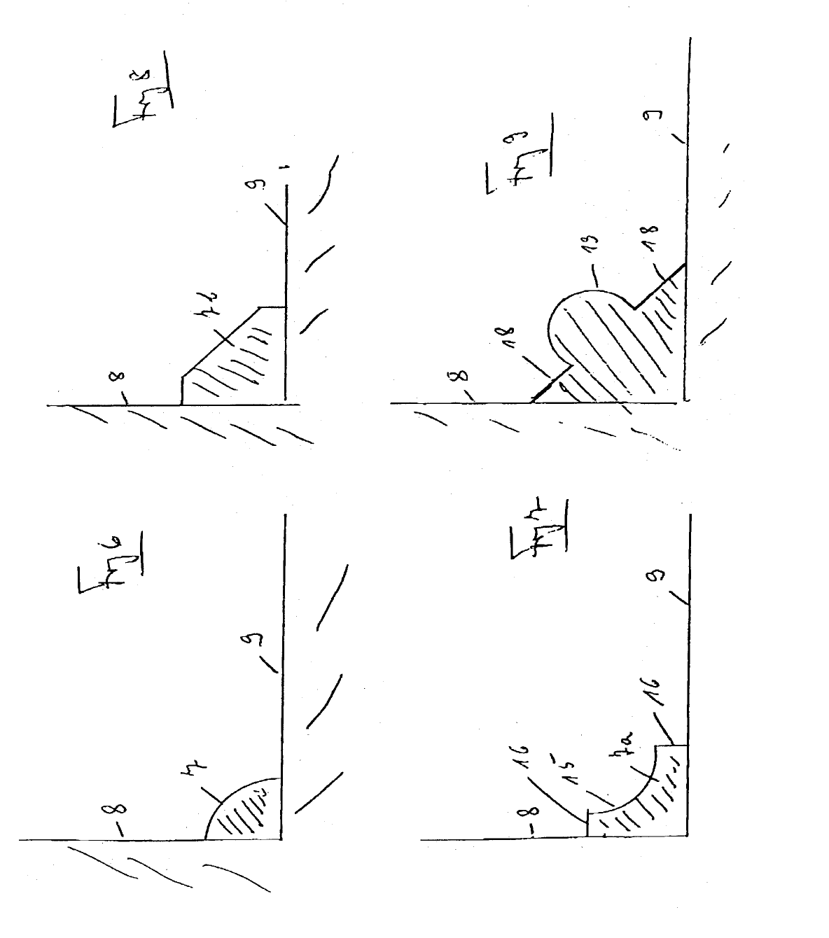

FIG. 3 shows a partial representation as a further possible embodiment of a tool 1a, in the area of the recess 10a formed between the two peripheral sides 3a and 4a, for forming a raised, overall convex corner joint 7a with a profile as can be seen in FIG. 7 likewise in the corner area between the two surfaces 8 and 9. Due to its special profile, the corner joint 7a has a concave partial surface 15, which connects with the joint surface 16 adjacent to the respective surface 8 or 9. Each joint surface 16 in the depicted embodiment is perpendicular to the adjacent surface 8 or 9.

The profile of the recess 10a matches this profile of the corner joint 7a, i.e. this recess forms a total of three surfaces, namely the two outer, essentially level surfaces 10a.1, which are beveled in relation to the top side 2.1 of the plate 2a and between these the likewise beveled, but convexly arched surface 10a.2. The peripheral sides 3 and 4 form an angle b, which in the embodiment depicted in FIG. 3 is likewise 90° or approximately 90°.

FIG. 4 shows in a representation similar to FIG. 3 as a further possible embodiment a tool 1b, which differs from the tool 1a essentially only in that the recess 10b that is likewise between the peripheral sides 3 and 4 of the tool body 2b and corresponds to the recess 10a, while displaying the two surfaces 10b.1 corresponding to the surfaces 10a. 1, instead of the convexly arched surface 10a.2, also has a beveled surface 10b.2. With the tool 1b, a raised corner joint 7b with the profile depicted in FIG. 8 can be produced between the two surfaces 8 and 9.

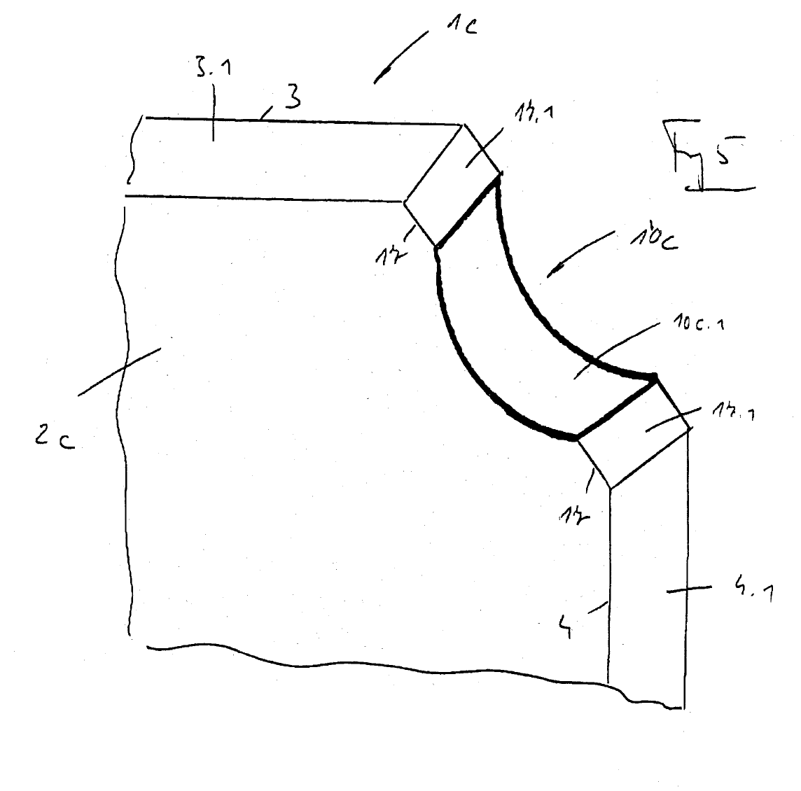

FIG. 5 shows in a representation similar to FIG. 3 as a further possible embodiment a tool 1c, which differs from the tool 1a essentially only in that the tool 1c or the plate 2c constituting this tool has a corner area that is beveled 45° in the depicted embodiment, i.e. an additional beveled peripheral side 17 in the corner area between the peripheral sides 3 and 4, and that the recess 10c is located on this side. With the tool 1c a raised joint 7c with the profile depicted in FIG. 9 can be produced between the two surfaces 8 and 9, the visible surface of which (profile) is formed by two partial surfaces 18 both extending at a slant to an adjacent surface 8 or 9 and a bead-like section 19 in between. On the peripheral sides 3 and 4, on the side 17 and in the area of the recess 10c this tool is likewise provided with the corresponding beveled surfaces 3.1, 4.1, 17.1 and 10c.1.

The invention was described above based on sample embodiments. Of course, modifications and variations are possible, without abandoning the underlying inventive idea of the invention. For example, it is possible to provide the respective recess for forming the raised joint on the transition between the peripheral sides that form an angle b other than 90°, for example between 85° and 110°.

1. Hand-held device or tool for forming plastic masses, especially for producing or forming raised profiles from a plastic mass that is pliant and that hardens after forming, with a plate-shaped tool body (2, 2a, 2b, 2c), which has at least two peripheral sides (3-6) that form a first angle (b) and that is provided with a chamfer (3.1-6.1) on these peripheral sides (3-6) characterized in that,
the tool body (2, 2a, 2b, 2c) is provided with a recess (10-13; 10a, 10b, 10c) on at least one corner formed by two peripheral sides and that the chamfer (3.1-6.1) of the two peripheral sides (3-6) continues in the recess (10-13; 10a, 10b, 10c) or in the slanted surfaces there (10.1-13.1; 10a.1, 10a.2; 10b.1, 10b.2, 10c.1).

2. Tool as claimed in claim 1, characterized in that it is designed as a plate (2, 2a, 2b, 2c).

3. Tool as claimed in claim 1 or 2, characterized in that the tool body has at least two corner areas, each with one recess, formed between two peripheral sides (10-13).

4. Tool as claimed in claim 3, characterized in that the recesses on different corner areas are of different sizes.

5. Tool as claimed in one of the foregoing claims, characterized in that the tool body is made of an elastic material, for example of an elastic plastic.

6. Tool as claimed in one of the foregoing claims, characterized in that the at least two peripheral sides (3-6) forming a corner area are straight.

7. Tool as claimed in one of the foregoing claims, characterized in that the at least two peripheral sides forming a corner area form an angle (b) greater than 85°, for example an angle of approximately 90°.

8. Tool as claimed in one of the foregoing claims, characterized in that the at least two peripheral sides forming a corner area form an angle (b) smaller than 75°.

9. Tool as claimed in one of the foregoing claims, characterized in that the at least one beveled surface in the area of the at least one recess forms the same angle or approximately the same angle with one top side (2.1) or bottom side (2.2) of the tool body (2) as the beveled surfaces (3.1-6.1) of the peripheral sides forming the corner area with the recess.

10. Tool as claimed in one of the foregoing claims, characterized in that the chamfers on the peripheral sides (3-6) forming the corner area form an angle (a) smaller than 90° but greater than 10° with one top side (2.1) or bottom side (2.2) of the tool body (2), for example an angle of approximately 45°.

11. Tool as claimed in one of the foregoing claims, characterized in that the tool body (2c) has a further beveled peripheral side (17) between two peripheral sides (3, 4) forming a corner area and that the at least one recess (10c) is located on this side (17).
